(19) United States
(12) Patent Application Publication
(10) Pub. No.: US 2015/0068978 A1
(43) Pub. Date: Mar. 12, 2015

(54) ENHANCMENT OF MEMBRANE ROBUSTNESS BY TREATMENT WITH IONIC MATERIALS

(71) Applicant: ADVANCED MEM-TCH LTD., Misgav (IL)

(72) Inventors: Gilad Lando, Rishon Lezion (IL); Dikla Zadaka-Amir, Rehovot (IL); Andrew Norman Shipway, Jerusalem (IL); Steve Daren, Nes-Ziona (IL)

(21) Appl. No.: 14/385,395

(22) PCT Filed: Mar. 14, 2013
(86) PCT No.: PCT/IL13/50243

§ 371 Date: Sep. 15, 2014

Related U.S. Application Data
(60) Provisional application No. 61/611,289, filed on Mar. 15, 2012.

(51) Int. Cl. B01D 71/68; B01D 67/00; B01D 65/06; B01D 71/58; B01D 71/12; B01D 71/56

(52) U.S. Cl. CPC B01D 71/68; B01D 71/12; B01D 71/56; B01D 65/06; B01D 71/58; B01D 67/0093; B01D 2321/168; B01D 2323/30; B01D 2323/36; B01D 2325/14; B01D 2325/16; B01D 2325/30; B01D 2325/22; B01D 2325/24
USPC 210/636; 210/500.21; 210/500.27; 210/500.25; 210/500.41; 210/500.29; 210/500.38; 210/638; 427/244; 252/182.32

(57) ABSTRACT

The disclosure is directed to an intermediate filtering membrane comprising: a filtering membrane having a charged or polar surface; and a transiently coupled charged compound, wherein the charged compound has an opposite charge to the membrane charge. Likewise, provided herein are methods and kits utilizing the intermediate membrane for various filtering membranes operations.

### BACKGROUND

The present disclosure relates to methods for treating membranes. Specifically, the disclosure relates to methods, kits and compositions for the temporary modification of filtering membranes made of charged polymers, before, during, and following various operations.

Membranes are discrete interfaces that modulate the permeation and selectivity of chemical and biological species in contact with it. For example, water filtration membranes allow water to penetrate through the membrane while preventing penetration of target species. Solutes and suspended impurities, such as colloids, bacteria, viruses, oils, proteins, salts, or other species, can be removed using a membrane. Polymer filtration membranes can be categorized into porous and nonporous membranes. In porous membranes, the transport barrier is considered as based on differences between the sizes of permeate and retentate species. In nonporous membranes, such as those used for reverse osmosis, the species are separated by means of relative solubility and/or diffusivity in the membrane material. For nonporous membranes and porous membranes for nanofiltration, poor chemical affinity between the membrane material and permeate that is passed across the membrane material, e.g., water, may inhibit permeability of the permeate.

Important parameters that can characterize a good membrane for liquid filtration include high flux, fouling resistance, and/or selectivity in the desired size range. An improvement in these properties can lead to improved membrane performance A membrane exhibiting high flux may decrease the cost of energy for pumping the solution through the membrane, which can make the process economical. Membranes that exhibit more uniform pore sizes can have higher selectivity and/or higher efficiency.

Membrane fouling is one of the more important problems in the membrane industry. It can generally be characterized by a decline in membrane flux over time caused by components in the feed solution passed across the membrane. It can occur due to the adsorption of molecules on pore walls, pore blockage, or cake formation on the membrane surface. Flux decline typically leads to higher energy requirements, and frequent cleaning is usually required to remedy this. This is only a temporary solution, and fouling typically ultimately reduces the lifetime of the membrane. As fouling often involves the adsorption of biomolecules to the membrane surface, it can also reduce the biocompatibility of the membranes in biomedical applications.

It has been observed that hydrophilic membrane surfaces foul less, especially in membranes with larger pore sizes such as those used in ultrafiltration (UF) and microfiltration (MF). Greater wettability may reduce adsorption on the membrane surface of species present in the solution. Moreover, membranes prepared from high polarity, hydrophilic polymers are known to have superior permeability properties for aqueous solutions than membranes from hydrophobic polymers. Another desirable property of hydrophilic surfaces is their superior resistance to biofouling.

On the other hand, high polarity polymers are usually more sensitive to chemical degradation or dissolution. For example, sulfonated polysulfone membranes are sensitive to alkaline aqueous solutions. Cellulose acetate membranes have low resistance to strong alkaline solutions or strong oxidizing agents; they are also sensitive to common organic solvents like acetone.

Frequently, membranes' life expectancy is dictated by the number or cumulative time of cleaning procedures, especially of clean-in-place procedures (CIPs). For example, one way to determine life expectancy of a UF membrane, is to fix its cumulative exposure to Sodium hypochloride at equal to 250,000 ppm at pH 11 and/or to 90,000 ppm Chlorine dioxide at pH 11. Frequent chemical washes may result in dissolution or even degradation of the membrane fibers. This will decrease membrane selectivity and may weaken it till it may rupture.

Since membranes are usually more susceptible during the cleaning cycles, any stability improvement treatment during or prior to the CIPs may result in a considerably longer membrane life periods.

### SUMMARY

In an embodiment, provided herein is an intermediate membrane comprising: a membrane having a charged or polar surface; and a transiently coupled charged compound, wherein the charged compound is complimentary to the membrane's surface charge or polarity.

In another embodiment, provided herein is a method of increasing the life of a filtering membrane and preserving its performance, the membrane having a charged or polar surface, the method comprises: prior to, or during a cleaning process, production or operation, contacting the membrane with a charged compound, wherein the charged compound is complimentary to the membrane's surface charge or polarity; and contacting the membrane with a cleaning solution, thereby transiently cross linking the charged surface of the membrane and increasing the life of the membrane.

In yet another embodiment, provided herein is a kit for the treatment of a negatively charged polymer membrane, the kit comprising: a solution of a multivalent positive ion, a cationic ionomer, a cationic molecule, or a combination comprising at least one of the foregoing, capable of transiently cross linking a plurality of negatively charged functional groups on the surface of the membrane; optionally packaging materials; and optionally instructions.

Provided is a method of increasing a charged or polarized membrane resistance to compression by liquid pressure, the method comprising: prior to, or during filtering process, contacting the membrane with a charged compound, wherein the charged compound is complimentary to the membrane's surface charge or polarity, thereby transiently cross linking the charged surface of the membrane and allowing the use of membranes at higher pressure applications, while maintaining higher permeability relative to untreated charged or polarized membrane.

### BRIEF DESCRIPTION OF THE DRAWINGS

The features of the non-retracting tearable indwelling endourethral catheter described will become apparent from the following detailed description when read in conjunction with the figures, which are exemplary, not limiting, and in which:

FIG. 1 shows the effect of pH on permeability;

FIG. 2 show the effect of treatment on membrane permeability as a function of pressure;

FIG. 3, shows the effect of ion concentration on permeability of hydrophilic Polysulfone (HPS) UF membrane (PS-30);

FIG. 4, shows the effect of ion concentration on permeability of Polyether Sulfone (PES) UF membrane (UP150);

FIG. 5, shows the effect of ion concentration on permeability of Poly(vinylidene fluoride) (PVDF) UF membrane (PVDF-400); and

FIG. 6, shows the effect of multivalent cation concentration on permeability of polar PS membrane at elevated pressure.

While the disclosure is amenable to various modifications and alternative forms, specifics thereof have been shown by way of example in the drawings and will be further described in detail hereinbelow. It should be understood, however, that the intention is not to limit the disclosure to the particular embodiments described. On the contrary, the intention is to cover all modifications, equivalents, and alternatives.

### DETAILED DESCRIPTION

The disclosure relates in one embodiment to methods for treating membranes. In another embodiment, the disclosure relates to methods, kits and compositions for the temporary modification of filtering membrane charged polymers before and during various operations.

The inventors hereof have discovered that, when a membrane (e.g., a filtration membrane) having a non-neutral surface charge density due to functional groups attached to the membrane, or physical treatment, such as corona discharge or plasma treatment, is treated with an agent complimentary to the surface charge or polarity of the membrane's surface and is capable of transiently cross linking the functional groups, or bridge polar moieties the robustness of the membrane is improved markedly. Provided herein is a treatment process that can be applied to filtration membranes constructed from polymers that bear a chemical functionality that is substantially polar and ionizable when in contact with the liquid filtration medium, to provide a non-neutral surface charge. The treatment improves membrane robustness towards key conditions, increasing membrane lifetime and enabling its use in otherwise unfeasible conditions.

As used herein, the term “complimentary” refers to a molecule having a charge or polarity that is opposite the charge or polarity (in other word, opposite dipole moment) of the membrane's surface.

Also, the treatment may be applied to provide enhanced stability for the membrane during working operation, and can be directed to enhancing stability for example during chemical wash cycles, where the pH (and/or other parameters) of the solution in contact with the membrane deviates significantly from standard operating parameters. Likewise, while the treatment may be an isolated process that may be applied e.g. during membrane manufacture or conditioning, the treatment can be intended to be carried out periodically, for example just before or during specific operations that are stressful to the membrane, in particular for chemical washing cycles during a clean-in-place (CIP) procedures, sanitation-in-place (SIP) procedures and chemically-enhanced-backwash (CEB).

The process described herein, is suitable for the treatment of membranes of all forms and geometries (e.g. flat sheet; spiral-wound; fiber; capillary; etc.) and for a broad range of technologies and applications including but not limited to desalination, waste water treatment, sterilization of beverages and pharmaceutics, beverages clarification, cell harvesting, water purification, metal recovery, oil-water separation, paints recovery, water softening, dyes retention, concentration of salts, sugars, beverages, milk and the like.

Accordingly, provided herein is a process by which certain polymeric (filtration) membranes may be strengthened and/or conditioned towards certain deleterious mechanisms by transiently treating the surface of the membrane with charged species that interact with one or more polymer chains to provide a chemically and/or mechanically more robust structure. This additional robustness can improve membrane lifetime and broaden the operational window of the membrane(s) by expanding the operational window (e.g. chemical, mechanical, and thermal conditions) the membrane may be subjected to, thus also improving the cost-effectiveness of membranes and the systems that comprise these membranes. The disclosed treatment may also enable certain new applications for specific membranes. In particular the robustness at high pH can be improved, which in turn can enable the use of aggressive chemical washing cycles, resulting in cleaner, higher-performing membranes.

“Robustness” as used herein, refers to the property of the membrane being insensitive to departures from the standard operating conditions on which the membrane was operationally qualified, such as the qualification of permeability at a given pressure or pH. Permeability can be based on trans-membrane flow (TMF, referring to the initial volume of liquid passing through the membrane wall within a given unit time) and is primarily expressed in l/(m² h bar). It can be calculated by division of Flux through trans-membrane pressure (TMP, referring to the difference between the feed pressure and filtrate pressure). The determination of permeability can be used to characterize the performance of membrane filtration systems independent of changes in the driving pressure and as a function of added complexing agent as described herein

In an embodiment, the membranes are constructed in whole or part from polymeric materials or mixtures thereof. While highly polar but nominally uncharged polymers can also be treated successfully using the methods described, the polymer will, for example have a negative charges density under operating conditions, due, for example, to the presence of carboxylic, sulfonic, phosphoric, boronic, or other acidic or charged groups. Polymers that bear negatively-charged groups can be for example; polyacrylic acid, sulfonated polysulfone, carboxylated polysulfone, polyamino acids, sulfonated polyethylene, etc their combinations, copolymers, blends and the like. In addition, polymers that are substantially neutral but are highly polarized and may be treated with the methods described herein, include without limitation; Polyvinylpyrrolidone, polyimide, polyether imide, polyamide, polyethersulfone, polyether ketone, polyether ether ketone, cellulose polymers, polyvinyl alcohol, polyester, polyether, polyether imide, poly(vinyl acetate), Polyethylene terephthalate, polyacrylates, polymethylacrylates, polyacrylonitrile, polyacrylonitrile, etc. Polymers that will have a positive net charge, may be for example; Zeta Plus (30S series) filters (AMF, Cuno Div., Meriden, Conn.), chitosan, Polyethylenimines, polylysine, polythiophene, and the like.

The term “charged polymer” refers to, without limitation, any polymer or oligomer that is charged. In other words, to any compound composed of a backbone of repeating structural units linked in linear or non-linear fashion, some of which repeating units contain positively or negatively charged chemical groups. The repeating structural units may be polysaccharide, hydrocarbon, organic, or inorganic in nature. Therefore, this term includes any polymer comprising an electrolyte, that is, a polymer comprising formal charges and its associated counter ions, the identity and selection of which is generally described herein. However, this term may also used to include polymers that can be induced to carry a charge by, for example, adjusting the pH of their solutions. The term “positively charged polymer” as used herein refers to cationic ionomers containing chemical groups which carry, can carry, or can be modified to carry a positive charge such as ammonium, alkyl ammonium, dialkylammonium, trialkyl ammonium, and quaternary ammonium. Conversely, the term “negatively charged polymer” as used herein refers to polymers containing chemical groups which carry, can carry, or can be modified to carry a negative charge such as derivatives of phosphoric and other phosphorous containing acids, sulfuric and other sulfur containing acids, nitrate and other nitrogen containing acids, formic and other carboxylic acids.

Likewise, the membrane may be comprised of otherwise non-charged polymer, which, through physical treatment may become polarizes, for example, by using corona discharge, performed at different atmospheres such as nitrogen atmosphere and oxygen atmosphere. Depending on the duration, pulsing, temperature and other factors, the surface may become polarized with a net positive or negative charge. In addition, plasma treatment (Pt) can be used to activate otherwise neutral polymer surfaces.

In an embodiment, the membrane composed of a charged polymer or polarized surface of an otherwise non-charged polymer, is treated with a solution of an oppositely charged species, which is expected to interact strongly with the charged polymer. For example, the polymer may be negatively charged and the treatment solution may contain multivalent metal ions. These ions can form strong complexes with the polymer, where each metal ion is able to interact with more than one polymer side chain resulting in crosslinking of the polymeric structure. Not wishing to be bound by theory, these chemical interactions may result in effecting improvements to the membrane stability due to masking of chemical functionality, the lowering of polarity, the improvement of mechanical properties, better resistance to compression at elevated pressures, the lowering of solubility, and the lowering of swelling, among other factors. Some of the advantages described herein may also be attained by the use of monovalent metal ions or other multiply charged treatment materials such as for example metal complexes, organometallic species, or polycationic oligomers or polymers. It should also be noted that in some cases, a mixture of species may be beneficial when compared to a single coordinating species, in order to provide the required stabilization. For example, the treatment material will increase the cross link density of the polymer by no less than 50%, no less than 100%, no less than 200%, no less than 250%, no less than 500%, based on the initial cross link density. As used herein, the term cross link density refers to:

$$\frac{\frac{\sum }{i} ( {F}_{i} - 2 ) {M}_{i}}{\frac{\sum }{i} {W}_{i}} \qquad ( Eqn . 1 )$$

wherein: Fᵢ is the functionality of the compound,

Mᵢ is the number of moles of the compound, and

Wᵢ is the molecular weight of the compound

The ability of multivalent complexing additives to form bridges or cross links between different polymer chains enables the treatment to slow or even reverse certain failure mechanisms of the membrane. In contrast to other crosslinking methods, this treatment can be carried out on membranes during their operation lifetime, and does not require the use of hazardous materials or high-cost chemical processes.

Other cationic, multicationic and polycationic materials that may be useful in the compositions and methods described herein include: Metal ions like uranyl, quaternary ammonium salts, polyquaterniums, Metal complexes etc. Examples of anionic materials that may be used for the treatment of anionic or highly polarized membranes may be common salt-forming anions like Acetate CH3COO—, Carbonate CO3 2-, Chloride Cl—, Bromide Br—, Citrate HOC(COO—)(CH2COO-)2, Nitrate NO3-, Nitrite NO2-, Oxide O2-, Phosphate PO4 3-, and Sulfate SO4 2-. poly(acrylic acid), sulfonated polymers, chromate, EDTA and the like. Cationic materials used in the compositions and methods provided herein further may include materials having functional groups which are cationic at virtually all pH values (e.g. quaternary amines) as well as those that can become cationic under acidic conditions or can become cationic through chemical conversion (potentially cationic groups, such as primary and secondary amines or amides). Likewise, cations refer to ionized atoms that have at least a one plus positive charge. The term “multivalent cations” refers for example to, ionized atoms that have at least a two plus charge; these are typically metal atoms. However, hydrogen and hydronium ions are also considered cations. Likewise, “anions” may be (non-toxic) anions such as chloride, bromide, iodide, fluoride, acetate, propionate, sulfate, bisulfate, oxalate, valerate, oleate, laurate, borate, citrate, maleate, fumarate, lactate, succinate, tartrate, benzoate, tetrafluoroborate, trifluoromethyl sulfonate, napsylate, tosylate, etc.

Suitable treatment material may depend not only on the strengthening effect that it produces, but on other factors such as cost, toxicity, solubility in the application solution, and regulatory approval. Considering all these factors together, in a specific example, the additive is a salt of Mg2+ or Ca2+. Non-limiting examples of other multivalent metal ions that may form the basis of the treatment include: Be2+, Sr2+, Ba2+, Ra2+, Mn2+, Zn2+, Cd2+, Cr(2+, 3+ or 6+); Fe(2+ or 3+); Al(2+ or 3+), Ti(3+ or 4+), Zr(3+ or 4+), V(2+, 3+, 4+ or 5+), Cr(3+ or +6), Co, Ni, Cu, Ag, Zn, Cd, Sn4+, Pb, etc.

In an embodiment, polymers having negatively-charged groups, forming the membranes which treatment is disclosed herein include for example, polyacrylic acid, sulfonated polysulfone, carboxylated polysulfone, polyamino acids, sulfonated polyethylene, etc. In addition, oligomers or polymers having negatively-charged groups may be used for the treatment of positively charged or polarized membrane's surfaces as described herein.

In an embodiment, the charged molecules, charged polymers and other ions adsorbed onto the surface of the charged membrane are configured to have an optimal concentration configured to be equal to the concentration yielding the Stern Plane. Also, ions complimentary to the surface charge or polarity can be applied in several layer, such that on a first treatment, the charged surface is, for example, negatively charged and the charged molecule will be positively charged and be present at a concentration that will alter the charge or polarity of the surface. The positively charged surface can then be optionally treated further with a negatively charged molecule, for example, a cationic ionomer having degree of polymerization of between 1 and 50. Accordingly, the multivalent ion, organic compound, complex, charged particle, charged polymer, can be adsorbed to the transiently coupled charged compound used initially as an additional layer. In an embodiment, the first charged compound is a multivalent ion, such as Calcium and the second adsorbed compound is PVP copolymers having positively charged amine, amide, modified amine or modified amide groups, with degree of polymerization, for example, between 2 and 50 monomers.

Treatment materials can be applied in aqueous solution, available in a form that is highly soluble. It may be beneficial for the aforementioned compounds to be dissolved as highly dissociated salts, thus enabling the treatment ion to interact with the charged site on the polymer chain, while its counter-ion will not compete. In addition, the counter-ion used may be selected to be cost-effective and not pose health or environmental hazard. For example, multivalent metal ions are used in the form of chloride or sulfate salts. Functional counter-ions useful in the treatment methods and compositions described herein may also be dodecylsulfate. When the treatment solution has substantially lower polarity than pure water, or is not aqueous, an alternative “soft” counter ions such as tetraphenylborate, hexafluorophosphate, and the like, may be employed.

In an embodiment, treatment materials are dissolved for example in a solution that is used to “wash” the membrane. Such “washing” may take the form of total immersion of the membrane in the solution, or an alternative process such as spraying of the membrane surface. The washing may take place before or after the membrane is sealed into a filtration module or connected to a filtration system, and may be carried out either under zero-flow, forward-flow or backflow conditions. Washing may take place during “forward flush” (FF) process, where, for example, flow is created along the inside of the membrane that can remove particles. In forward flushing, the filtrate outlet port is closed and water will be discharged through the concentrate port for a short period. Likewise, the washing using the intermediate membranes, methods and kits described herein, can take place during Backwash (BW) or chemically-enhanced-backwash (CEB), where a chemical cleaning agent is added to the backwash flow, which remains in the membrane module for a short period of soaking time. The cleaning agent will be discharged together with components of the fouling layer by a final backwash after a strong reverse filtrate flow is applied for a predetermined period. It should be noted, that treatment as described herein, sing the intermediate membranes, methods and kits described herein, can increase the membrane tolerance of trans-membrane pressure (TMP, in other words, the difference between the feed pressure and filtrate pressure). In addition, the intermediate membranes, methods and kits described herein, can be used, for example during CIP process, where the cleaning solution flow is conducted across the membrane surface, allowing the use of elevated temperatures. CIP requires more equipment and a longer interruption of filtration service than CEB.

It is even possible for the treatment to take place during membrane manufacture. After the “wash”, the membrane may or may not be rinsed as a part of the treatment process. Other parameters such as the concentration, temperature and time of treatment may also be variable. However, the treatment can be carried out at ambient temperature on the fully operational membrane in a sealed filtration module, and at a slow flow speed. Likewise, prior to washing, the membrane may be washed with the typical clean filtration medium liquid, to remove any solid debris.

Since membrane interaction with the treatment system; for example, the complexation of hydrophilic groups with large multivalent ions may decrease membrane hydrophilicity, porosity, bio-fouling resistance and mechanical flexibility, it is useful for the treatment to be partly or wholly reversible (i.e. transient). As such, the treatment can be applied before or during a specific operation that it is intended to fortify the membrane against (for example, a high pH washing cycle), and part or all of the applied treatment material will be removed during an additional washing or normal operation subsequently to said specific operation. Thus, the treatment may be applied periodically each time that fortification is required, and as such the requirements for cost effectiveness and environmental benignity are enhanced. A desired level of reversibility can be obtained by choosing treatment ions that have suitable thermodynamic and kinetic parameters for their interaction with the membrane polymer, wherein combination of treatment ions may be employed for example to achieve an optimal solution.

Cross linking, bridging, or complexation of the polar functional groups may be non-transient. In other words, the affinity of the cross-linking and/or complexing compounds used to the charged groups on the membrane is strong enough to last for more than a single wash cycle, longer operation periods, elevated pressure and the like. Accordingly, the cross-linking and/or complexing compounds will not be removed from the membrane without the presence of a compound specifically designated to remove the cross-linking and/or complexing compounds. Affinity of the compounds described herein may be the function of several types of chemical interactions, e.g., electrostatic forces, hydrogen bonding, hydrophobic forces, and/or van der Waals forces.

The ability of multivalent complexing additives to form bridges between different polymer chains can make it possible for the treatment to slow or even reverse certain failure mechanisms of the membrane or to substantially regenerate the membrane's capabilities. In contrast to other crosslinking methods, this treatment can be carried out on membranes during their operation lifetime, and does not require the use of hazardous materials or high-cost chemical processes.

In another embodiment, the intermediate membranes disclosed herein are used in the methods described herein. Accordingly, provided herein is a method of increasing the life of a filtering membrane and preserving its performance, the membrane having a charged or polar surface, the method comprises: prior to, after, or during a cleaning process, production or operation, contacting the membrane with a charged compound, wherein the charged compound has an opposite charge to the membrane charge; and contacting the membrane with a cleaning solution, thereby transiently cross linking the charged surface of the membrane and increasing the life of the membrane. As used herein, the term “intermediate membrane” refers to a charged membrane having a complexing agent adsorbed thereon and reflects circumstances where the complexing agent is transiently adsorbed. Accordingly, and in one embodiment, the membrane is carboxylated poly(sulfone) membrane, having a cationic ionomer, such as polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing, their oligomer or copolymer comprising at least one of the foregoing transiently adsorbed thereon. The term “transiently adsorbed” refers to a non-permanent change to the surface of the membrane, upon which the surface charge, after a certain period of time will return to its value or behavior prior to said change, and refers to a membrane surface that is structurally distinct and chemically differentiated than e.g., the carboxylated poly(sulfone) membrane itself. Likewise, the term “adsorbed” and grammatical variations thereof, when used to refer to a relationship between a substance, such as a cationic ionomer such as a poly(lysine) oligomer and a substrate such as carboxylated poly(sulfone) membrane, means that the substance binds to the substrate. There can be several modes of adsorptive binding of cationic ionomers, a multivalent ion, an organic compound, a complex, a charged particle, a charged polymer, or a combination comprising at least one of the foregoing, to substrates.

For example; physical non-ionic binding, ionic binding and covalent binding. Physical non-ionic binding is where the surface of the substrate (in other words, the membrane) has physical properties (hydrophobic areas, for example) that bind to the molecule via van der Walls forces, hydrogen bonds or other strong non-ionic or non-covalent interactions. The degree of non-ionic binding is a function of the physical properties of the molecule and the substrate. Ionic binding is where a molecule has a charge that interacts with an opposite charge on the surface of the substrate. The charge of the molecule will be influenced by the pH and salt content of the fluid, if present. Ionic binding is therefore influenced by pH and salt concentration. Ionic binding is a medium strength bond, stronger than physical non-ionic binding but weaker than covalent bonding. Covalent binding is a binding reaction in which a chemical reaction forms a covalent bond between the molecule and substrate. Any of these three may be involved in mediating adsorption of a molecule to surface of a substrate.

Also provided herein is a kit for the treatment of a negatively charged polymer filtering membrane, the kit comprising: a solution of a multivalent positive ion, a cationic ionomer, a cationic molecule, or a combination comprising at least one of the foregoing, capable of transiently cross linking a plurality of negatively charged functional groups on the surface of the membrane; a counter ion solution, wherein the counter ion is capable of effectively removing the multivalent positive ion; optionally packaging materials; and optionally instructions.

Detailed embodiments of the present systems are disclosed herein; however, it is to be understood that the disclosed embodiments are merely exemplary, which can be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the membrane(s) includes one or more membrane). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

A more complete understanding of the methods and systems disclosed herein can be obtained by reference to the accompanying Examples. These examples are merely illustrative, and are, therefore, not intended to limit the scope of the exemplary embodiments.

### EXAMPLES

### Materials

Polysulfone polymer having weight average molecular weight of 20,000, of analytical purity was obtained from Aldrich and used as received. n-butyl lithium was obtained commercially from Aldrich as a 1.6M solution in hexane and used as received. Anhydrous dimethyl sulfoxide (DMSO) was obtained from Aldrich. Anhydrous CaCl2 was obtained from Aldrich. Fluorescent nanoparticles were purchased from Thermo Scientific. They have 28 nm diameter and are made from Polystyrene that contains fluorescent dyes. Excitation was performed at 542 nm and emission was performed at 612 nm

### Example 1

### Preparation of Carboxylated Polysulfone UF Membranes

Carboxylated polysulfone polymer was synthesized as described in patent WO2009024973. Commercial Udel type polysulfone (PS, MW=20,000) was reacted with n-buthyl lithium. The obtained lithiated product was reacted with carbon dioxide and then was acidified to obtain carboxylated PS as described in the structure illustrated by formula 1 below:

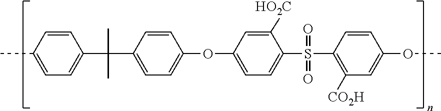

wherein sulfone is present in an amount of 12 mol % based on the weight of the polysulfone, n is an integer having average value of 30 to 60 and the arylate rings may comprise other substituents, and the polymer may be graft, branched or linear.

UF membranes were prepared by a non-solvent induced phase transition method.

### Example 2

### Increase of PH and Temperature-Resistance in Carboxylated PS Membranes by Calcium Addition

Carboxylated PS flat sheet membrane were cut into 8 disc samples of 4 cm diameter each, prepared as described in example 1. Samples were then placed into four 200 ml covered plastic cups. Three (3) cups were inserted into 50° C. oven and one was kept at room temperature of 25±3° C. The cups contained Distilled water and Potassium hydroxide (KOH) to meet the required pH. The forth cup had CaCl₂ added.

The Cup's pH and temperature are described below:

(a) pH 11, 50° C.

(b) pH 11, 25+3° C.

(c) pH 10, 50° C.

(d) pH 11, 50° C.+400 ppm CaCl2

Each week the samples were tested in a round dead end pressure cell at 1 Bar pressure. The experimental solution was an aqueous solution with 100 ppm fluorescent nanoparticles with a diameter of 28 nm. The concentration of both, feed solution and permeate were analyzed by a fluorescence meter. The detection limit of the fluorescence sensor was 0.7 ppm.

Results are listed below:

TABLE 1

| | Initial | NPs passage | NPs passage | NPs passage |
|---|---|---|---|---|
| Cup | selectivity | 1st week | 2nd week | 3rd week |
| (a) pH 11, 50° C. | Nano particles | a1) destroyed | NA | NA |
| | (NPs) passage | a2) 15.0% | | |
| (b) pH 11, 25 ± 3° C. | <0.7% | b1) <0.7% | b1) <0.7% | b1) 1.5% |
| | | b2) <0.7% | b2) 1.7% | b2) 7.0% |
| (c) pH 10, 50° C. | | c1) <0.7% | c1) 1.0% | c1) 3.5% |
| | | c2) <0.7% | c2) 2.0% | c2) 9.0% |
| (d) pH 11, 50° C. | | d1) <0.7% | d1) <0.7% | d1) <0.7% |
| 400 ppm CaCl₂ | | d2) <0.7% | d2) <0.7% | d2) <0.7% |

As demonstrated in Table 1, the combination of pH 11 and high temperature destroyed or dramatically reduced untreated membranes barrier to 28 nm nano particles in less than one week. Even at lower pH or temperature, the membranes lost some selectivity after 2 weeks. Only in the case when metal ions of CaCl2 were induced to the solution, the membranes does not show decrease in selectivity after 3 weeks. This result indicates that addition of CaCl2 to alkali cleaning solutions improve negatively charged carboxylated PS membranes resistance and prolong their operational life expectancy.

### Example 3

### Increase of PH-Resistance in Carboxylated Polysulfone Membranes by Continuous Mixed Salt Treatment

2 circular discs of 4 cm diameter were cut from carboxylated PS flat sheet membrane that was prepared as described in example 1. The samples permeability was tested in a round dead end pressure cell at 1 Bar pressure. Permeability was measured by weighting permeate obtained in 1 minute and dividing the result by membrane active area and pressure. Permeability units are Liter/(Square meter*hour*Bar) or in short LmhB Each sample was pressurized first at pH 7 until the permeability stabilized and was measured. Then at pH 8 till stabilization and measurement and again at pH 8.5, 9 and 10.

The difference between the procedures was that sample one was pressured with distilled water+potassium hydroxide solutions, while sample two was pressured by sea water+potassium hydroxide solutions.

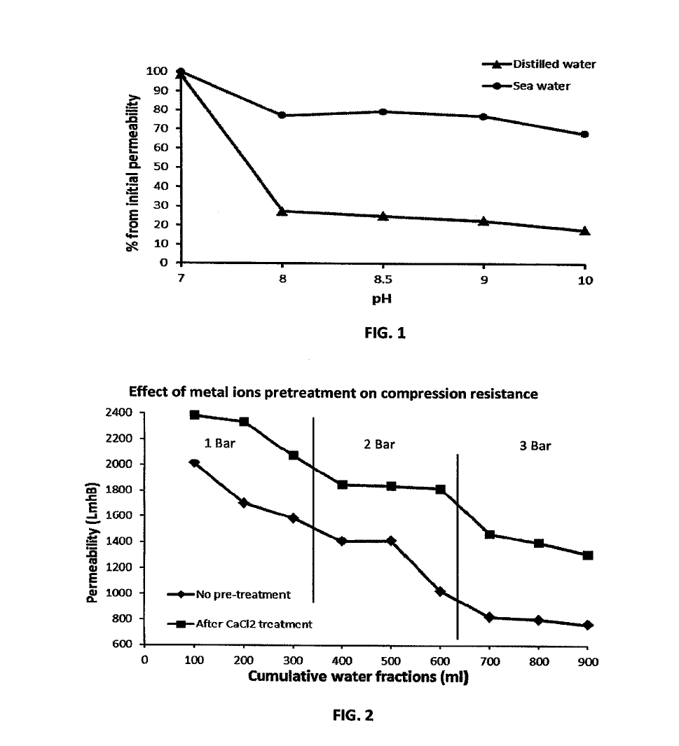

As illustrated in FIG. 1, membrane's permeability with alkaline sea water was less sensitive than the membrane's permeability with alkaline distilled water. Since sea water contains high concentrations of NaCl, MgCl2 and CaCl2 salts sea water was able to treat the negatively charged membrane surface. Even though sea water is more dense than distilled water and permeability at pH 7 was 810 LmhB for distilled water and only 625 LmhB for sea water, at Alkaline pH the trend was reversed, for example, at pH 10 distilled water permeability was only 145 LmhB while sea water permeability was 550 LmhB.

It is presumed that the decrease in permeability of carboxylated PS at alkaline pH is due to dissolution and release of small membrane pieces—leading to blocking of the membrane pores. The results indicate that working at alkaline environment with salt solution (or salt addition) is beneficial; and is due to the metal ions presence.

### Example 4

### Increase of PH-Resistance in Carboxylated Polysulfone Membranes by Various Pre-Treatments

7 disc samples of 4 cm diameter were cut from carboxylated PS flat membrane sheet, prepared as described in example 1. The disc sample's permeability was tested in a round dead end pressure cell at 1 Bar pressure. Each sample was first pressurized by distilled water until the permeability reached steady state and was then measured. Then, 100 ml of pre-treatment solution was passed by pressure trough the membrane and after 5 minutes, permeability in the pre-treatment solution was measured. Next, a solution of potassium hydroxide in distilled water having a 11.5 pH passed under pressure trough the membrane, until the permeability stabilized and was then measured. Pretreatment solutions composed of NaCl, MgCl₂, CaCl₂ and combination (sea water) were used to test the efficiency of different metal monovalent and divalent ions, at different concentrations. In the first test pre-treatment was done with metal free-distilled water.

Results are listed below:

TABLE 2

| | | Permeability | Permeability in |
|---|---|---|---|
| Initial Permeability | Pre-treatment | after Pre- | pH 11 |
| (LmhB) | solution | treatment | (% from initial) |
| 802 | Distilled water | 789 | 200 (25%) |
| 700 | Sea water | 525 | 380 (54%) |
| 609 | 1000 ppm NaCl | 678 | 240 (39%) |
| 780 | 1600 ppm MgCl₂ | 751 | 524 (67%) |
| 861 | 80 ppm MgCl₂ | 906 | 571 (66%) |
| 1013 | 1600 ppm CaCl₂ | 960 | 842 (83%) |
| 856 | 80 ppm CaCl₂ | 812 | 661 (77%) |

As demonstrated in Table 2, without pre-treatment membranes permeability was dramatically decreased, metal ions pre-treatment increased resistance. Monovalent metal ions (Na⁺) increase resistance (permeability decreased to 39% instead of 25%). Divalent metal ions (Mg²⁺ and Ca²⁺) have a higher impact, (MgCl₂ 66-67% and CaCl₂ 77-83%). Sea water composed of both mono and divalent metal ions shows intermediate impact (permeability decrease to 54%). As shown, increase in salt concentration shows a lower impact on preserving permeability than an increase in valency (from 1⁺ to 2⁺) and size of the ion used (from Mg²⁺ to the larger Ca²⁺), indicating an optimum concentration per surface area. Not wishing to bound by theory, it is possible that the optimal concentration may be the one corresponding to the Stern plane. In the Stern (inner) layer between the membrane surface and the Stern plane the adsorbed molecules may be considered to be immobile, and thermal diffusion may not be strong enough to overcome electrostatic, or Van der Waals forces and they will attach to the surface to become specifically adsorbed. As shown, a 20 fold increase in concentration resulted in only a one and 6 percent increase in permeability of magnesium and calcium ions respectively.

The results indicate that metal ion pretreatment—prior to alkaline (caustic) treatment can be helpful in increasing membrane resistance to elevated pH (pH>10), such as when divalent (or multivalent) metal ions were used.

### Example 5

### Increase of Compression Resistance of Carboxylated Polysulfone Membranes by CaCl₂ Pretreatment

2 disc samples of 4 cm diameter each were cut from carboxylated PS flat sheet membrane prepared as described in example 1. One disc was kept in distilled water while the other disc was dipped for 20 minutes in a 80 ppm CaCl₂ solution and then washed for 2 minutes under tap water. The sample's permeability was then tested in a round dead end pressure cell with distilled water. Permeability was measured using 3×100 ml fractions at increasing pressure. 3 fractions of 100 ml distilled water were applied at 1 Bar. 3 fractions were applied at 2 Bars and 3 fractions were applied at 3 Bars.

Membranes treated and untreated with metal ions were expected to show similar permeability at low pressures, while at relatively high pressures the treated membrane was expected to show higher resistance to compression—and thus higher permeability. Surprisingly, as shown in FIG. 2, a significant permeability difference was already observed after filtration of the first fraction at 1 Bar. The results demonstrate that the treatment described herein may be effective to fortify sheet membranes that are sensitive to compression. As shown in FIG. 2, with increase in pressure, the treated membranes show superior tolerance to compression; with the average permeability being 28% higher at 1 Bar, 43% higher at 2 Bars and 75% higher at 3 Bars.

The results indicate that pretreatment with metal ion—is useful in increasing membrane resistance to compression by water pressure, allowing the use of membranes at higher pressure applications, while keeping high permeability.

### Example 6

### Increase of Compression Resistance of Commercial Membranes by CaCl₂ Treatment

The treatment was further evaluated for other polar-charged membranes, whereby 3 Different commercial membranes were tested by forming 4 cm discs from each of:

a) Nadir® flat sheet Polyether Sulfone (PES) UF membrane (UP150).

b) Sepro flat sheet hydrophilic Polysulfone (HPS) UF membrane (PS-30).

c) Sepro flat sheet Poly(vinylidene fluoride) (PVDF) UF membrane (PVDF-400)

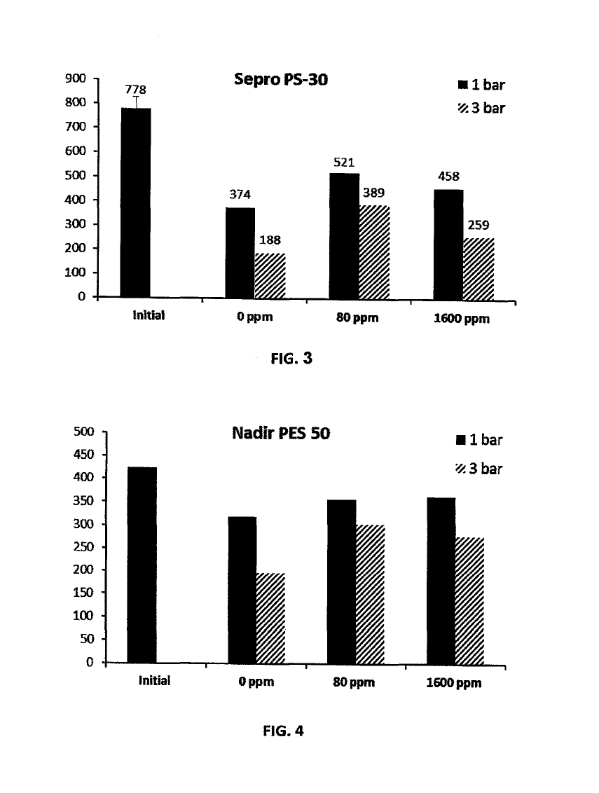

The disc samples were first hydrated for 30 minutes at 40° C. using distilled water. Each sample was then subjected to pressure in a round dead end pressure cell with CaCl₂ salt solution with concentration of 0 ppm, 80 ppm or 1600 ppm. The samples were subject to pressure for 30 minutes at 1 Bar pressure and then for additional 30 minutes at 3 Bar pressure. Permeability was tested at the beginning (t=0), after 30 minutes at 1 Bar and after 30 minutes at 3 Bars, Results are illustrated in FIG. 3.

Similar to the results shown in Example 4, commercial polar membranes that were pretreated with metal ion solutions showed higher resistance to compression and thus their permeability decreased to a lesser extent compared to membrane samples that were not pretreated.

The effect of pretreatment were even more evident for samples under 3 bar pressure. For example, hydrophilic Poly(sulfone) (PS) samples permeability decreased by 76% when pressed by clean water and only by 50% when pretreated by 80 ppm CaCl₂ Salt. Interestingly, the higher addition of 1600 ppm CaCl₂ did not improve the results and in many cases was less efficient, again indicating there is an optimal concentration of pretreatment ions that provide the highest impact. When polar molecules concentration is higher than salt concentration; some Ca⁺⁺ molecules can approach 2 polar sites in the membrane and act as a crosslinking agent.

Similarly, Poly(ethersulfone) also shows (See FIG. 4), that pretreatment of the membrane with a divalent counter-ion results in reduction of the decrease in permeability, however, the higher salt concentration does not seems to exacerbate the decrease as in the PS.

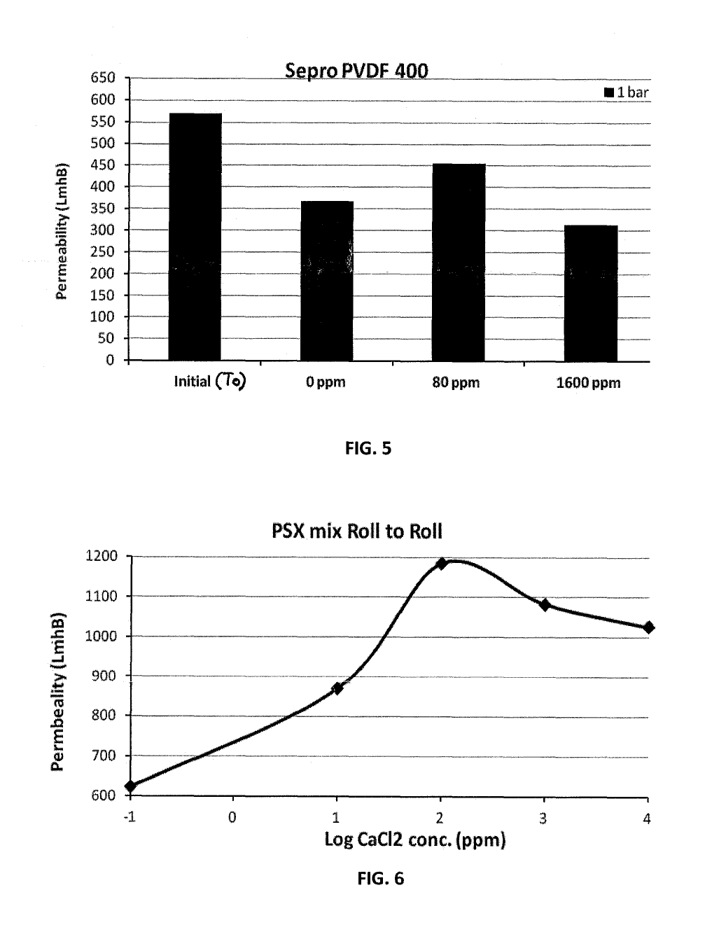

Although Poly(vinylidene fluoride) (PVDF) membranes ruptured at the higher pressure (3 Bar), results shown in FIG. 5 still show that the smaller salt concentration results in improved permeability compared to both untreated membrane and membrane treated with higher salt concentration.

The results demonstrate the effectiveness of treatment of polar membranes with counter ions capable of bridging polar groups on the surface of the membrane.

### Example 7

### Effect of Polycationic Ionomers on Membrane Permeability

As shown in Example 4, increase in valency and size of cross linking agent showed a significant effect on permeability and resistance of membrane to pressure compressing the membrane.

To examine the effect of positively charged oligomers on permeability and membrane resistance to pressure-induced compression is evaluated.

4 cm discs are formed of Carboxylated PS, PS, PES and PVDF as in Example 1 and Example 6. Discs made of each membrane polymer are treated using 100 ml of pre-treatment solution containing positively charged oligomer for 30 minutes at 40 C. Then, the samples are inserted into a pressure cell and pressed by clean water flow 30 minutes at 1 bar pressure and 30 minutes at 3 bars pressure. Permeability is recorded initially (t₀), after 30 minutes, and after 60 minutes. Pretreatment solutions composed of polyethyleneimine (PEI), poly-L-lysine (PLL), diethylaminoethyl-dextran (DEAE-dextran), chitosan, and calcium/iron polyacrylate are used to test the efficiency of different polycationic ionomers, at different concentrations and degrees of polymerization are used.

Membranes pretreated with the polycationic ionomers show a decreased reduction in permeability and higher resistance to pressure induced compression compared to untreated membranes, that is directly proportional to the charge density of the ionomer and inversely proportional to the degree of polymerization with diminishing return on size (in other words, the lower the degree of polymerization, the higher the impact on permeability and resistance to a minimum beyond which any reduction does not significantly affect the response.

The results show that using specific polycationic ionomers absorbed on the surface of specific polyanionic membranes or using a system of polyanionic bridges together with multivalent metals, at optimal charge density with optimal concentration of absorbed bridging/cross-linking agents can be effective in mitigating the reduction in membrane permeability at high pH value existing during CIP processes and increase the resistance of the membrane to pressure induced compression.

### Example 8

### Compression Resistance Dependence on CaCl2 Concentrations

The treatment was further evaluated for polar-charged membranes, whereby carboxylated poly(sulfone) membrane was tested by forming 4 cm discs:

The disc samples were first hydrated for 30 minutes at 40° C. using distilled water. Each sample was then subjected to pressure in a round dead end pressure cell with CaCl2 salt solution with concentration of 0 ppm, 10 ppm, 100 ppm, 1000 ppm or 10,000 ppm. The samples were subject to pressure for 30 minutes at 2 Bar pressure. Permeability was evaluated after 30 minutes, Results are illustrated in FIG. 6

Similar to the results shown in Example 5 and 6, polar membranes that were treated with complimentary metal ion solutions showed higher resistance to compression and thus their permeability decreased to a lesser extent compared to membrane samples that were pressed with pure water.

The effect of metal ion addition was especially evident for carboxylated poly(sulfone). When pressed with pure water it's permeability decreased to 623 (L/m²hB) while the small addition of 100 ppm CaCl₂ resulted in a much better resistance to pressure and a permeability of 1185 (L/m²hB).

As Shown in FIG. 6, further increasing the salt concentration resulted in a decrease in the pressure resistance—due, in an embodiment, to lower formation of crosslinking/bridging bonds.

In an embodiment, provided herein is an intermediate filtering membrane comprising: a filtering membrane having a charged or polar surface; and a transiently coupled charged compound, wherein the charged compound is complimentary to the membrane's surface charge or polarity, wherein (i) the charged compound is a multivalent ion, an organic compound, a complex, a charged particle, a charged polymer, or a combination comprising at least one of the foregoing; wherein (ii) the multivalent ion is a positively charged metal ion such as Mg⁺², Ca⁺², Be⁺², Sr⁺², Ba⁺², Ra⁺², Mn⁺², Zn⁺², Cd⁺², cr(⁺², ⁺³ or ⁺⁶); Fe(⁺² or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing; wherein (iii) the multivalent ion is a uranyl ion, a quaternary ammonium compound, a polyquaternium salt or a combination comprising at least one of the foregoing; wherein (iv) the charged compound is a salt of an anionic material such as Acetate, Carbonate, Citrate HOC(COO⁻)(CH₂COO⁻)₂, Nitrate, Nitrite, Oxide, Phosphate, Sulfate, or a combination comprising at least one of the foregoing; (v) further comprising a multivalent ion, an organic compound, a complex, a charged particle, a charged polymer, or a combination comprising at least one of the foregoing, complimentary to the transiently coupled charged compound, the multivalent ion, organic compound, complex, charged particle, charged polymer, adsorbed to the transiently coupled charged compound as an additional layer; wherein (vi) the membrane is made from polyacrylic acid, polylactic acid, sulfonated polysulfone, carboxylated polysulfone, poly(lactic acid), sulfonated polyethylene, poly sulfone (PS), polyether sulfone (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, their copolymers, Sulfonated PS, Cellulose, Polyimide, Poly(ether imide), or poly(ether ketone) (PEEK) or a combination comprising at least one of the foregoing; wherein (vii) the charged polymer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing; and/or (viii) an oligomer of polyethyleneimine (PEI), poly-L-lysine (PLL), diethylaminoethyl-dextran (DEAE-dextran), or chitosan, having a degree of polymerization between 5 and 50; and wherein (ix) the membrane is formed of carboxylated poly(sulfone) and the charged compound is CaCl₂, MgCl₂, or their combination present at a water solution concentration of between about 10 and about 1000 ppm (w/v), for example between about 20 ppm to about 800 ppm, or between about 30 to about 500 ppm, specifically, between about 40 ppm to about 300 ppm, or between about 50 to about 200 ppm, more specifically, between about 60 ppm to about 150 ppm, or between about 70 to about 120 ppm of the charged compound in a water solution,

In another embodiment, provided is a method of increasing the life of a membrane and preserving its performance, the membrane having a charged or polar surface, the method comprises: prior to, or during a cleaning process, production or operation, contacting the membrane with a charged compound, wherein the charged compound is complimentary to the membrane's surface charge or polarity; and contacting the membrane with a cleaning solution, thereby transiently cross linking the charged surface of the membrane and increasing the life of the membrane; wherein (x) the process is clean-in-place (CIP), sanitation-in-place (SIP), chemical-enhanced-backwash (CEB), high pressure backwash, high pressure forward flush, or a cleaning process comprising at least one of the foregoing; (xi) the charged compound is a multivalent ion, an organic compound, a complex, a charged particle, a charged polymer, or a combination comprising at least one of the foregoing; (xii) the multivalent ion is a positively charged metal ion such as Mg⁺², Ca⁺², Be⁺², Sr⁺², Ba⁺², Ra⁺², Mn⁺², Zn⁺², Cd⁺², Cr(⁺², ⁺³ or ⁺⁶); Fe(⁺² or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing; wherein (xiii) the multivalent ion is a uranyl ion, a quaternary ammonium compound, a polyquaternium salt or a combination comprising at least one of the foregoing; (xiv) the charged compound is anionic material such as Acetate, Carbonate, Citrate HOC(COO⁻)(CH₂COO⁻)₂, Nitrate, Nitrite, Oxide, Phosphate, Sulfate, or a combination comprising at least one of the foregoing; wherein (xv) the membrane is made from polyacrylic acid, sulfonated polysulfone, carboxylated polysulfone, poly(lactic acid), sulfonated polyethylene, poly sulfone (PS), polyether sulfone (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, their copolymers, or a combination comprising at least one of the foregoing; (xvi) the charged polymer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing; wherein (xvii) the charged polymer is an oligomer of polyethyleneimine (PEI), poly-L-lysine (PLL), diethylaminoethyl-dextran (DEAE-dextran), PVP having positively charged amine, amide, modified amine or modified amide groups, or chitosan, having a degree of polymerization between 5 and 50; wherein (xviii) the membrane is formed of carboxylated poly(sulfone) and the charged compound is CaCl₂, MgCl₂, or their combination present at a water solution concentration of between about 10 and about 1000 ppm (w/v) wherein (xix) the membrane is formed of carboxylated poly(sulfone) and the charged compound is a positively charged or polarized polymer, copolymer or oligomer; and (xx) further comprising the step of contacting the intermediate membrane with a multivalent ion, an organic compound, a complex, a charged particle, a charged polymer, or a combination comprising at least one of the foregoing, complimentary to the transiently coupled charged compound.

In yet another embodiment, provided herein is a kit for the treatment of a negatively charged polymer filtering membrane, the kit comprising: a solution of a multivalent positive ion, a cationic ionomer, a cationic molecule, or a combination comprising at least one of the foregoing, capable of transiently cross linking a plurality of negatively charged functional groups on the surface of the membrane; a counter ion solution, wherein the counter ion is capable of effectively removing the multivalent positive ion; optionally packaging materials; and optionally instructions, wherein (xxi) the negatively charged polymer of the filtering membrane is poly(acrylic acid), sulfonated poly(sulfone), carboxylated poly(sulfone), poly(lactic acid), sulfonated poly(ethylene), poly sulfone (PS), poly(ether sulfone) (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, their copolymers, or a combination comprising at least one of the foregoing; wherein (xxii) the multivalent ion is Mg⁺², Ca⁺², Be⁺², Sr⁺², Ba⁺², Ra⁺², Mn⁺², Zn⁺², Cd⁺², Cr(⁺², ⁺³ or ⁺⁶); Fe(⁺² or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing; the cationic molecule is a uranyl ion, a quaternary ammonium compound, a polyquaternium salt or a combination comprising at least one of the foregoing; and the cationic ionomer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing; wherein (xxiii) the solution comprises CaCl₂, MgCl₂, or their combination present at a water solution concentration of between about 10 and about 1000 ppm (w/v); wherein (xxiv) the solution comprises a positively charged or polarized polymer, copolymer or oligomer; and (xxv) further comprising a solution of a multivalent negative ion, an anionic ionomer, an anionic molecule, or a combination comprising at least one of the foregoing.

While in the foregoing specification the methods, kits and compositions for the temporary modification of filtering membranes made of charged polymers, before, during, and following various operations described herein have been described in relation to certain embodiments, and many details are set forth for purpose of illustration, it will be apparent to those skilled in the art that the disclosure of the methods, kits and compositions for the temporary modification of filtering membranes made of charged polymers, before, during, and following various operations described herein are susceptible to additional embodiments and that certain of the details described in this specification and as are more fully delineated in the following claims can be varied considerably without departing from the basic principles of this invention.

We claim:

1. An intermediate filtering membrane comprising:
a. a membrane having a charged or polar surface; and
b. a transiently coupled charged compound, wherein the charged compound is complimentary to the membrane's surface charge or polarity.

2. The intermediate membrane of claim 1, wherein the charged compound is a multivalent ion, an organic compound, a complex, a charged particle, a charged polymer, or a combination comprising at least one of the foregoing.

3. The intermediate membrane of claim 2, wherein the multivalent ion is a positively charged metal ion such as Mg⁺², Ca⁺², Be⁺², Sr⁺², Ba⁺², Ra⁺², Mn⁺², Zn⁺², Cd⁺², Cr(⁺², ⁺³ or ⁺⁶); Fe(⁺² or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing.

4. The intermediate membrane of claim 2, wherein the multivalent ion is a uranyl ion, a quaternary ammonium compound, a polyquaternium salt or a combination comprising at least one of the foregoing.

5. The intermediate membrane of claim 2, wherein the charged compound is anionic material such as Acetate, Carbonate, Citrate HOC(COO⁻)(CH₂COO⁻)₂, Nitrate, Nitrite, Oxide, Phosphate, Sulfate, or a combination comprising at least one of the foregoing.

6. The intermediate membrane of claim 1, further comprising a multivalent ion, an organic compound, a complex, a charged particle, a charged polymer, or a combination comprising at least one of the foregoing, complimentary to the transiently coupled charged compound, the multivalent ion, organic compound, complex, charged particle, charged polymer, adsorbed to the transiently coupled charged compound as an additional layer.

7. The intermediate membrane of claim 1, wherein the membrane is made from polyacrylic acid, sulfonated polysulfone, carboxylated polysulfone, poly(lactic acid), sulfonated polyethylene, poly sulfone (PS), polyether sulfone (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, Sulfonated PS, Cellulose, Polyimide, Poly(ether imide), poly(ether ketone) (PEEK), their copolymers, or a combination comprising at least one of the foregoing.

8. The intermediate membrane of claim 2, wherein the charged polymer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing.

9. The intermediate membrane of claim 7, wherein the charged polymer is an oligomer of polyethyleneimine (PEI), poly-L-lysine (PLL), diethylaminoethyl-dextran (DEAE-dextran), or chitosan, having a degree of polymerization between 5 and 50.

10. The intermediate membrane of claim 1, wherein the membrane is formed of carboxylated poly(sulfone) and the charged compound is CaCl₂, MgCl₂, or their combination present at a water solution concentration of between about 10 and about 1000 ppm (w/v)

11. The intermediate membrane of claim 1, wherein the membrane is formed of carboxylated poly(sulfone) and the charged compound is a positively charged or polarized polymer, copolymer or oligomer.

12. A method of increasing the life of a filtering membrane and preserving its performance, the membrane having a charged or polar surface, the method comprises: prior to, or during a cleaning process, production, or operation, contacting the membrane with a charged compound, wherein the charged compound is complimentary to the membrane's charge or polarity; and contacting the membrane with a cleaning solution, thereby transiently cross linking the charged surface of the membrane and increasing the life of the membrane.

13. The method of claim 12, wherein the process is clean-in-place (CIP), sanitation-in-place (SIP), chemical-enhanced-backwash (CEB), high pressure backwash, high pressure forward flush, or a cleaning process comprising at least one of the foregoing.

14. The method of claim 12, wherein the charged compound is a multivalent ion, an organic compound, a complex, a charged particle, a charged polymer, or a combination comprising at least one of the foregoing.

15. The method of claim 14, wherein the multivalent ion is a positively charged metal ion such as Mg⁺², Ca⁺², Be⁺², Sr⁺², Ba⁺², Ra⁺², Mn⁺², Zn⁺², Cd⁺², cr(⁺², ⁺³ or ⁺⁶); Fe(⁺² or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing.

16. The method of claim 14, wherein the multivalent ion is a uranyl ion, a quaternary ammonium compound, a polyquaternium salt or a combination comprising at least one of the foregoing.

17. The method of claim 14, wherein the charged compound is anionic material such as Acetate, Carbonate, Citrate HOC(COO⁻)(CH₂COO⁻)₂, Nitrate, Nitrite, Oxide, Phosphate, Sulfate, or a combination comprising at least one of the foregoing.

18. The method of claim 12, wherein the membrane is made from polyacrylic acid, sulfonated polysulfone, carboxylated polysulfone, poly(lactic acid), sulfonated polyethylene, poly sulfone (PS), polyether sulfone (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, their copolymers, or a combination comprising at least one of the foregoing.

19. The method of claim 14, wherein the charged polymer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing.

20. The method of claim 19, wherein the charged polymer is an oligomer of polyethyleneimine (PEI), poly-L-lysine (PLL), diethylaminoethyl-dextran (DEAE-dextran), PVP having positively charged amine, amide, modified amine or modified amide groups, or chitosan, having a degree of polymerization between 1 and 50.

21. The method of claim 12, wherein the membrane is formed of carboxylated poly(sulfone) and the charged compound is CaCl₂, MgCl₂, or their combination present at a water solution concentration of between about 10 and about 1000 ppm (w/v)

22. The method of claim 12, wherein the membrane is formed of carboxylated poly(sulfone) and the charged compound is a positively charged or polarized polymer, copolymer or oligomer.

23. The method of claim 12, further comprising the step of contacting the intermediate membrane with a multivalent ion, an organic compound, a complex, a charged particle, a charged polymer, or a combination comprising at least one of the foregoing, complimentary to the transiently coupled charged compound.

24. A kit for the treatment of a negatively charged polymer membrane, the kit comprising:
a. a solution of a multivalent positive ion, a cationic ionomer, a cationic molecule, or a combination comprising at least one of the foregoing, capable of transiently cross linking a plurality of negatively charged functional groups on the surface of the membrane;
b. optionally packaging materials; and
c. optionally instructions.

25. The kit of claim 24, wherein the negatively charged polymer of the filtering membrane is poly(acrylic acid), sulfonated poly(sulfone), carboxylated poly(sulfone), poly(lactic acid), sulfonated poly(ethylene), poly sulfone (PS), poly(ether sulfone) (PES), hydrophilised PS or PES, hydrophilised poly(vinylidene fluoride) PVDF, poly(acrylonitrile) (PAN), cellulose acetates (CA), PVP copolymer having sulfonic acid or carboxylic acid groups, their copolymers, or a combination comprising at least one of the foregoing.

26. The kit of claim 24, wherein:
the multivalent ion is Mg⁺², Ca⁺², Be⁺², Sr⁺², Ba⁺², Ra⁺², Mn⁺², Zn⁺², Cd⁺², Cr(⁺², ⁺³ or ⁺⁶); Fe(⁺²or ⁺³); Al(⁺² or ⁺³), Ti(⁺³ or ⁺⁴), Zr(⁺² or ⁺⁴), V(⁺², ⁺³, ⁺⁴ or ⁺⁵), Cr(⁺³ or ⁺⁶), Co, Ni, Cu, Ag, Zn, Cd, Sn⁺⁴, Pb, or a combination comprising at least one of the foregoing;
the cationic molecule is a uranyl ion, a quaternary ammonium compound, a polyquaternium salt or a combination comprising at least one of the foregoing; and
the cationic ionomer is polyethyleneimine (PEI), poly-L-lysine (PLL), diethylaminoethyl-dextran (DEAE-dextran), PVP copolymers having positively charged amine, amide, modified amine or modified amide groups, or chitosan, their oligomer or copolymer comprising at least one of the foregoing.

27. The kit of claim 24, wherein the solution comprises CaCl₂, MgCl₂, or their combination present at a water solution concentration of between about 10 and about 1000 ppm (w/w)

28. The kit of claim 24, wherein the solution comprises a positively charged or polarized polymer, copolymer or oligomer.

29. The kit of claim 24, further comprising a solution of a multivalent negative ion, an anionic ionomer, an anionic molecule, or a combination comprising at least one of the foregoing.
